(19) United States
(12) Patent Application Publication
(10) Pub. No.: US 2025/0229618 A1
(43) Pub. Date: Jul. 17, 2025

(54) BRACKET ASSEMBLY FOR ATTACHING COMPONENT TO VEHICLE

(71) Applicant: VOLVO TRUCK CORPORATION, Göteborg (SE)

(72) Inventors: Sondre LANDVIK, Göteborg (SE); Sebastien RAGOT, Göteborg (SE)

(73) Assignee: VOLVO TRUCK CORPORATION, Göteborg (SE)

(21) Appl. No.: 18/852,171

(22) PCT Filed: Apr. 7, 2022
(86) PCT No.: PCT/IB2022/053291

§ 371 Date: Sep. 27, 2024

(51) Int. Cl. B60K 1/04; B60K 15/067

(52) U.S. Cl. CPC B60K 1/04; B60K 15/067; B60K 2001/0455

(57) ABSTRACT

A bracket for securing components to a vehicle includes a base part adapted to be attached to a frame of a vehicle, the base part including a first interface structure. A bracket assembly includes a first element having a first end and a second end, the first end being movably coupled to the component. A second interface structure is arranged at the second end. The first element is configured to move between a first position in which the second interface structure engages with the first interface structure to secure the component to the frame via the bracket assembly and a second position in which the second interface structure is disengaged from the first interface structure.

### TECHNICAL FIELD

Embodiments of the present disclosure relate generally to an apparatus for attaching a component to a vehicle, and more specifically, to a bracket assembly for attaching a battery to the frame of a vehicle.

### BACKGROUND

Battery Electric Vehicles (BEVs) and Fuel Cell Electric Vehicles (FCEVs) are continuing to be more prevalent. Producing BEVs and FCEVs with so many new components is very challenging on existing production lines which are designed for traditional diesel and gas powered vehicles. When assembling BEVs and FCEVs, it is important to match the same short tact time in assembling traditional vehicles, as well as to not disturb the production flow and assembly sequence of the current vehicle portfolio.

It is desirable for serviceability that no non-related system needs to be removed to detach a certain system. For example, the batteries should be able to remove without removing the fuel tanks. Production and service technicians also often need different access points, where production is very focused on ergonomics and cannot access below the vehicle, while service sites can lift the truck to access from below. Thus, the BEV and FCEV components should meet these sometime competing goals.

Further, rough road conditions require special installations for the battery packs and fuel cells in order to handle vibration and acceleration levels, as well as to allow the vehicle frame to twist, as this is an important feature of traditional frame rails on trucks and other heavy vehicles. In addition, collision safety is of importance. The battery packs and other components should be protected from side collision and intrusion as this can result in catastrophic failure and thermal events.

Therefore, an improved assembly system that provides a sturdy interface while at the same time allowing components to be installed exceptionally quickly and easily on a production line is desired.

### BRIEF SUMMARY

According to an embodiment, an apparatus for securing components to a vehicle may comprise a base part adapted to be attached to a frame of a vehicle, the base part including a first interface structure; and a bracket assembly including a first element having a first end and a second end, the first end being movably coupled to the component; a second interface structure arranged at the second end, wherein the first element is configured to move between a first position in which the second interface structure engages with the first interface structure to secure the component to the frame via the bracket assembly and a second position in which the second interface structure is disengaged from the first interface structure.

According to an embodiment, a vehicle may comprise a pair of frame rails spaced apart from each other and defining a space therebetween; base parts coupled to each of the frame rails, the base parts including a first interface structure facing outwardly from the space between the frame rails; bracket assemblies, each having a first end and a second end, the second end provided with a second interface structure complementary to the first interface structure, the first ends being moveably attached at opposite sides of a component in order to move between a first position in which the second interface structure engages with the first interface structure to secure the component to the frame rails via the bracket assembly and a second position in which the second interface structure disengages from the first interface structure; and fasteners securing the bracket assembly to the component in the first position, whereby the component is coupled to the frame rails via the bracket assemblies.

According to an embodiment, a method of securing a component to a vehicle, the vehicle having a pair of frame rails spaced apart from each other and defining a space therebetween, may comprise attaching a base part to each of the frame rails, outside of the space between the frame rails, the base parts each including a first interface structure; providing a component having a bracket assembly, the bracket assembly including a first end and a second end opposite the first end, the second end having a second interface structure complementary to the first interface structure, the first end being moveably attached to the component, the bracket assembly being moveable to a first position in which the second interface structure engages with the first interface structure to secure the component to the frame rails via the bracket assembly; positioning the component under the frame rails such that the bracket assembly is aligned with a respective base part; moving the bracket assembly into the first position; and securing the bracket assembly into the first position.

According to an embodiment, an apparatus includes a fuel tank bracket, the fuel tank bracket having a horizontal component and a vertical component defining a profile configured to receive a fuel tank, the vertical component having a top end, the horizontal component having a bottom end, the bottom end defining a recess to receive a hook, the vertical component being attached to a vehicle frame; a panel having two faces opposite each other; and a complimentary fuel tank bracket attached to a first of the faces of the panel, the complimentary fuel tank bracket having a top end, a bottom end, and surface therebetween defining a profile configured to receive the fuel tank, the complimentary fuel tank bracket includes a hook at the bottom end configured to interface with the recess at the bottom end of the fuel tank bracket.

### ASPECTS OF THE DISCLOSURE

According to an embodiment, an apparatus for securing components to a vehicle, comprise a base part adapted to be attached to a frame of a vehicle, the base part including a first interface structure; and a bracket assembly including a first element having a first end and a second end, the first end being movably coupled to the component; a second interface structure arranged at the second end, wherein the first element is configured to move between a first position in which the second interface structure engages with the first interface structure to secure the component to the frame via the bracket assembly and a second position in which the second interface structure is disengaged from the first interface structure.

According to an embodiment, the vehicle includes a frame rail, the first interface structure includes a protrusion that extends in a horizontal direction laterally outward from the frame rail and includes a bottom portion located closer to the frame than a top portion that extends laterally outward relative to the frame and the bottom portion; and the second interface structure engaging the protrusion when in the first position and extending circumferentially around the protrusion, whereby the bracket assembly and component are connected to the frame rail via the protrusion.

According to an embodiment, the first interface structure may comprise a bushing.

According to an embodiment, the bushing has a first stiffness in a vertical direction to absorb a weight of the component, and a second stiffness in a horizontal direction.

According to an embodiment, the bracket assembly may further comprise a second element, the second element includes a first end and a second end opposite the first end, a first face between the first and second ends of the second element and facing the component when attached to the component, and a second face opposite the first face, and wherein the first element includes a first face between its first and second ends, and a second face opposite the first face, wherein the first end of the first element is rotatably connect to the first end of the second element, and in the first position the first face of the first element faces the second face of the second element.

According to an embodiment, the second face of the first element is configured to receive a fuel tank bracket.

According to an embodiment, may further comprise fasteners extending through the first element into the second element to secure the bracket assembly in the first position.

According to an embodiment, the component is at least one of a battery module, tool box, and fuel tank.

According to an embodiment, the component is the intermediary frame, and further comprising a fuel tank bracket attached to the intermediary frame, the fuel tank bracket having a horizontal component and a vertical component defining a surface configured to receive a fuel tank, the vertical component having a top end, the horizontal component having a bottom end, the bottom end defining a recess to receive a hook; a panel having two faces opposite each other; a complimentary fuel tank bracket attached to a first of the faces of the panel, the complimentary fuel tank bracket having a top end, a bottom end, and surface therebetween that fits an exterior profile of the fuel tank, the complimentary fuel tank bracket include a hook at the bottom end configured to interface with the recess of the fuel tank bracket.

According to an embodiment, a safeguard is connected to the panel, the safeguard having a profile corresponding to an outer profile of the fuel tank, the safeguard being made of a dense foam material.

According to an embodiment, a reinforcing structure is provided on a second of the faces of the panel.

According to an embodiment, the reinforcing structure comprises horizontal ribs.

According to an embodiment, a strap is connected between the top end of the fuel bracket and the top end of the complimentary fuel bracket.

According to an embodiment, an interface panel is connected in between the panel and a second panel to hold the panel and the second panel together.

According to an embodiment, a plurality of fuel tank brackets are coupled to the intermediary frame, and spaced apart from each other; and a bottom panel is connected to the horizontal component of each of the fuel tank brackets, and extends a same width as the horizontal component and along the spaced apart distance in between the fuel tank brackets.

According to an embodiment, a vehicle may comprise a pair of frame rails spaced apart from each other and defining a space therebetween; base parts coupled to each of the frame rails, the base parts including a first interface structure facing outwardly from the space between the frame rails; bracket assemblies, each having a first end and a second end, the second end provided with a second interface structure complementary to the first interface structure, the first ends being moveably attached at opposite sides of a component in order to move between a first position in which the second interface structure engages with the first interface structure to secure the component to the frame rails via the bracket assembly and a second position in which the second interface structure disengages from the first interface structure; and fasteners securing the bracket assembly to the component in the first position, whereby the component is coupled to the frame rails via the bracket assemblies.

According to an embodiment, the component is disposed in the space between the frame rails.

According to an embodiment, the component is suspended below the frame rails via the bracket assembly.

According to an embodiment, the first interface structure comprises a bushing.

According to an embodiment, the bushing is attached directly to frame rail.

According to an embodiment, the bracket assemblies may further comprise a first element having the first end, the second end opposite the first end, a first face between the first and second ends, and a second face opposite the first face; and a second element including a first end and a second end opposite the first end, the first end rotatably coupled to the first end of the first element; a first face between the first and second ends of the second element and facing the component; and a second face opposite the first face, wherein in the first position the first face of the first element faces the second face of the second element.

According to an embodiment, the fasteners extend through the bracket assembly towards the component.

According to an embodiment, a fuel tank bracket may be connected to at least one of the second faces of the first elements.

According to an embodiment, a plurality of base parts may be coupled to each frame rail and a corresponding number of bracket assemblies.

According to an embodiment, a second component may be coupled to the component or to the bracket assembly opposite of the component.

According to an embodiment, the base parts are arranged on sides of the frame rails facing away from the space between the frame rails.

According to an embodiment, a method of securing a component to a vehicle, the vehicle having a pair of frame rails spaced apart from each other and defining a space therebetween, may comprise attaching a base part to each of the frame rails, outside of the space between the frame rails, the base parts each including a first interface structure; providing a component having a bracket assembly, the bracket assembly including a first end and a second end opposite the first end, the second end having a second interface structure complementary to the first interface structure, the first end being moveably attached to the component, the bracket assembly being moveable to a first position in which the second interface structure engages with the first interface structure to secure the component to the frame rails via the bracket assembly; positioning the component under the frame rails such that the bracket assembly is aligned with a respective base part; moving the bracket assembly into the first position; and securing the bracket assembly into the first position.

According to an embodiment, the bracket assembly may comprise a first element having the first end, the second end opposite the first end, a first face, and a second face opposite the first face; and a second element including a first end and a second end opposite the first end, the first end rotatably connect to the first end of the first element, a first face between the first and second ends of the second element and facing the component, and a second face opposite the first face, wherein in the first position, the first face of the first element faces the second face of the second element, and the method may further comprise moving the first element to the first position such that the second face of the second element faces the second face of the first element; and attaching the first element to the second element to secure the bracket assembly in the first position.

According to an embodiment, the securing the bracket assembly into the first position may comprise inserting fasteners through the first element towards the component and into the second element to secure the bracket assembly in the first position.

According to an embodiment, the method may comprise attaching the bracket assembly to the component.

According to an embodiment, the method may comprise attaching a fuel tank bracket to the component.

According to an embodiment, an apparatus, comprises an intermediary frame configured to house a component; a fuel tank bracket, the fuel tank bracket having a horizontal component and a vertical component defining a profile configured to receive a fuel tank, the vertical component having a top end, the horizontal component having a bottom end, the bottom end defining a recess to receive a hook, the vertical component being attached to the intermediary frame; a panel having two faces opposite each other; and a complimentary fuel tank bracket attached to a first of the faces of the panel, the complimentary fuel tank bracket having a top end, a bottom end, and surface therebetween defining a profile configured to receive the fuel tank, the complimentary fuel tank bracket includes a hook at the bottom end configured to interface with the recess at the bottom end of the fuel tank bracket.

According to an embodiment, the apparatus includes a safeguard connected to the first of the faces of the panel, the safeguard having a profile configured to receive the fuel tank, the safeguard being made of a dense foam material.

According to an embodiment, the apparatus includes a reinforcing structure provided on a second of the faces of the panel.

According to an embodiment, the reinforcing structure comprises horizontal ribs.

According to an embodiment, the apparatus includes a strap connected between the top end of the fuel bracket and the top end of the complimentary fuel bracket.

According to an embodiment, the apparatus includes an interface panel connected in between the panel and a second panel to hold the panel and the second panel together.

According to an embodiment, the apparatus includes a plurality of fuel tank brackets coupled to the intermediary frame, and spaced apart from each other; and a bottom panel, the bottom panel connected to the horizontal component of each of the fuel tank brackets, and extending a same width as the horizontal component and along the spaced apart distance in between the fuel tank brackets.

According to an embodiment, an apparatus includes a fuel tank bracket, the fuel tank bracket having a horizontal component and a vertical component defining a profile configured to receive a fuel tank, the vertical component having a top end, the horizontal component having a bottom end, the bottom end defining a recess to receive a hook, the vertical component being attached to a vehicle frame; a panel having two faces opposite each other; and a complimentary fuel tank bracket attached to a first of the faces of the panel, the complimentary fuel tank bracket having a top end, a bottom end, and surface therebetween defining a profile configured to receive the fuel tank, the complimentary fuel tank bracket includes a hook at the bottom end configured to interface with the recess at the bottom end of the fuel tank bracket.

### BRIEF DESCRIPTION OF DRAWINGS

The description below refers to the following drawings of which:

FIG. 1A shows a bracket, according to an embodiment of the disclosure;

FIG. 1B shows a bracket, according to another embodiment of the disclosure;

FIG. 2 shows perspective view of a bracket, according to an embodiment of the disclosure;

FIG. 3 shows another view of a bracket, according to an embodiment of the disclosure;

FIG. 4 shows a bracket attached to a vehicle frame, according to an embodiment of the disclosure;

FIG. 5 shows a bracket attached to a vehicle frame, according to another embodiment of the disclosure;

FIG. 6 shows another embodiment of the disclosure;

FIG. 7 shows a frame and protection panel, according to an embodiment of the disclosure;

FIG. 8 shows a bracket and protection panel, according to an embodiment of the disclosure;

FIG. 9 shows a protection panel, according to an embodiment of the disclosure;

FIG. 10 shows a bracket detail, according to an embodiment of the disclosure;

FIG. 11 shows a detail of an attachment mechanism, according to an embodiment of the disclosure; and

FIGS. 12 and 13 show a cross section view of a bracket and protection panel, according to an embodiment of the disclosure.

### DETAILED DESCRIPTION

The present disclosure relates to a bracket assembly. The bracket assembly may be used to attach one of more components, such as a battery pack, to a frame of a vehicle. The installation concept is focused on the wheelbase area of a vehicle, and the bracket assembly provides a sturdy interface while at the same time allowing it to be installed exceptionally quickly and easily on a production line. Embodiments of the invention are described in the context of BEVs, FCEVs, heavy-duty trucks, and the like with a battery pack and H2 tanks. Embodiments of the invention can however be applied to a range of other vehicles and types of devices, and components other than battery packs.

In exemplary embodiments of the invention, one or several battery packs and/or other components are preferably mounted together as one unit. On this unit, a plurality of bracket assemblies may be mounted. The bracket assemblies may include a bracket and a base part. The bracket has a first element movably mounted to the battery unit, for example via a hinge, joint, coupling, etc. The bracket assemblies may be mounted on opposite sides of the battery unit, and may be spaced apart from each other in a longitudinal direction along the length of the battery unit.

The base part of the bracket assembly is mounted on the vehicle frame, with the same spacing in the longitudinal direction along the frame as the spacing of the first elements on the battery unit. The base part may include bushings, brackets with rubber bushings, and the like.

The unit with brackets form a substantially rigid structure, and can easily and quickly be mounted to the vehicle frame on the assembly line. One location for this is at the axle docking station where the vehicle frame is lowered onto the axles. Here, the battery assembly can be located in between the axles, for example front and rear axles, and when the frame is in the correct assembly position. The bracket may be rotated about the hinge and onto the rubber bushing of the base part. The bracket may then be secured in place via fasteners, clamps, etc. For example, screws may be threaded through the bracket and into the battery unit. This ensures a secure fixation of the complete unit (battery unit and bracket) onto the vehicle frame.

In a further exemplary assembly process, fuel tank brackets may be mounted to the vehicle frame members or to the battery structure. The fuel tank brackets may also be integrated with the bracket assemblies. The fuel tank brackets may be used to hold H2, or other substances. This also may be done in connection with a standard diesel vehicle. In exemplary embodiments, the fuel tank brackets may be mounted directly to the battery unit after the battery unit is installed on the vehicle. The procedure, assembly station, etc. is the same, but the result is that the complete energy module of the wheelbase area may be suspended as one unit underneath the vehicle chassis. This reduces the need of clearances for relative motion between the parts. It also reduces the risk of chafing on cables, etc. And it also results in lower acceleration levels on this large mass, which is beneficial for the batteries and actuator valves on the fuel tanks. As such, rougher road conditions can be tolerated with this suspension concept.

An intermediary frame may be used to house the battery packs. This allows service technicians to remove a battery without affecting other installed systems. The intermediary frame may also allow the same installation to be used with only one battery pack, where a second frame would instead have a sub-frame within it to ensure proper stiffness during operation.

Assembly of the component is flexible with different processes available. For example, the battery may supported by a dolly and the chassis is lowered down to the battery pack, The battery pack may be placed on a dolly or fixture and slid in from the side, underneath the chassis. The battery pack may be lifted up from a lower section in the factory floor, to be joined with the cassis.

In addition, a center portion of the unit, such as the battery packs and intermediary frames may be assembled first and docked to the vehicle, before assembling the outside structures. Or the left hand side structures are assembled with the center portion, which is docked to the vehicle, before the right hand structure is assembled. In both cases the assembly sequence allows for easy handling on an assembly line, with hook and hang features for the operators to have proper access to connection points without tools blocking the view or access paths.

Another benefit is that different sizes of fuel tanks may be mounted on the outside of the vehicle frame. The fuel tanks may be different in both in length and in height in case larger ground clearances or lower chassis heights are needed.

Another benefit is that mounting the battery unit in the center of the frame provides a much more efficient packaging for packing energy. The cylindrical fuel tanks can be arranged outside the frame volume, which results in larger diameter tanks, which is beneficial for composite pressure vessels. This results in longer driving range for the customer.

Yet another potential benefit is that the batteries are protected in the vehicle center, far from any collision zone, e.g. from passenger cars in side collision. In an example, crash protection panels may be provided for the unit, such as, composite pressure vessels to provide crash worthiness in side collision. A tank-mounted crash structure may be provided to distribute crash loads onto the fuel tank and further into the rest of the suspended installation. Here, the crash structure dissipates the first energy before the large mass of the suspended unit is allowed to move laterally. This in turn will cause the frame mounted bushings to come to a bump stop where the loads are further transferred into the vehicle chassis.

Details of exemplary systems and methods to achieve the aforementioned advantages and benefits are described herein. However, alternatives to the structure, layout, size, arrangement, etc., are contemplated without departing from the goals and scopes of an improved bracket according to embodiments of the present disclosure.

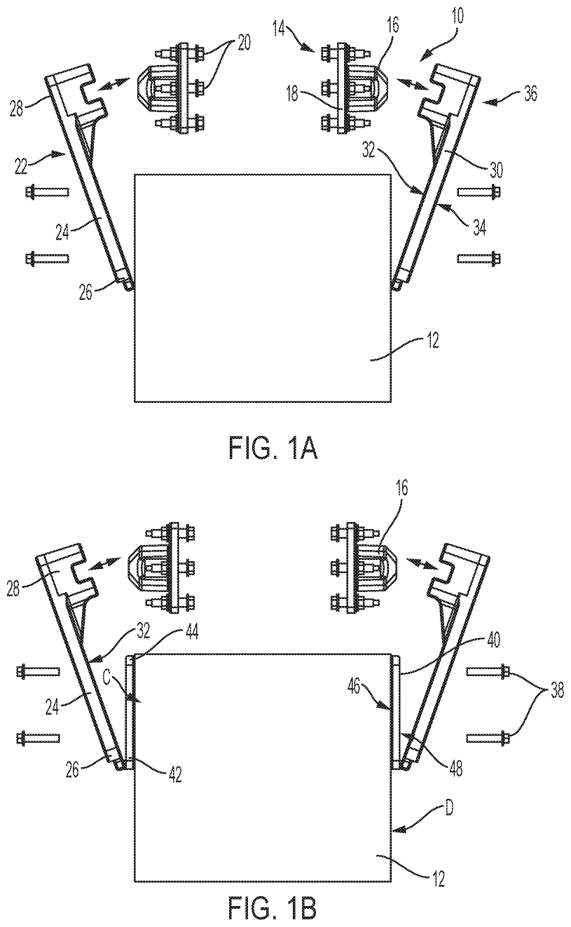

Referring to FIGS. 1a and 1b, a device 10 to secure a component 12 in place, for example to a vehicle, is shown. The component may be many different items associated with the vehicle, for example, battery pack, tool box junction boxes, air compressors, power-take-off devices, a frame/carrier to receive other components, etc. In the described embodiments, the device is a bracket. The bracket may include a base part 14. The base part 14 may include an interface structure 16, such as a bushing, etc., and a face plate 18. The bushing 16 may be made from a flexible material, rubber for example. The bushing 16 may have a first stiffness in a first direction (vertical in the context of FIG. 1) that is sufficient to absorb a weight of the component. The bushing 16 may have a second stiffness in a second direction (into the page in the context of FIG. 1). In some embodiments the second stiffness may be softer than the first stiffness. The bushing may accommodate vibrations, bumps in a road surface, flex in the frame of the vehicle and the like. The bushings may absorb the weight of the attached components, dampen acceleration levels in the vehicle frame, and isolate the components from, for example, frame twisting. The stiffnesses may vary based on the particular implementation.

As shown in FIGS. 1a and 1b, the bushing 16 may be secured to the face plate 18. The face plate 18 supports the bushing 16 and serves to connect the base part 14 to the vehicle frame. The face plate 18 may define a number of holes arranged in a pattern that aligns with a pattern of holes in the vehicle frame. Screws, bolts, rivets or other fasteners 20 may be inserted into the holes to attach the base part 14 to the frame. Other means of attaching the face plate 18 may also be used, such as clamps, adhesives, etc. In some embodiments, the face plate and bushing may be an integral bushing.

The bushing 16 has an outer profile defining its shape. The outer profile of the bushing 16 may be tapered. For example, the outer profile may be tapered such that the bushing 16 is wider at its bottom adjacent the face plate 18, and is narrower at its opposite end. A top portion of the bushing 16 may have the shape of a truncated pyramid, cone, or the like.

With continued reference to FIGS. 1a and 1b, a bracket assembly 22 may be made from a strong material such as steel, aluminum, plastic, etc. The bracket assembly 22 includes a first element 24. The first element 24 has a first end 26 and a second end 28 opposite each other, with a mid-portion 30 in between. The first element 24 has a first face 32 between the first and second ends 26, 28, and a second face 34 opposite the first face 32. The first and second faces 32, 34 may be planar. The first element 24 is movably coupled to the component 12 at the first end 26 of the first element. For example, the first end 26 may be movable about a hinge, joint, and the like, that connects the first element 24 to the component 12.

The second end 28 of the first element 24 includes a second interface structure 36. The second interface structure 36 engages with the first interface structure, bushing 16, to secure the component 12 to the frame via the bracket assembly 22. The second interface structure 36 may include a head portion arranged at the second end 28 of the first element 24. The head portion defines a shape that substantially conforms to the shape of the bushing 16. For example, the head portion may define a shape that that fits over the bushing 16 as shown in FIGS. 1A and 1B, with an interior cavity that has a shape complementary to the outer profile of the bushing 16.

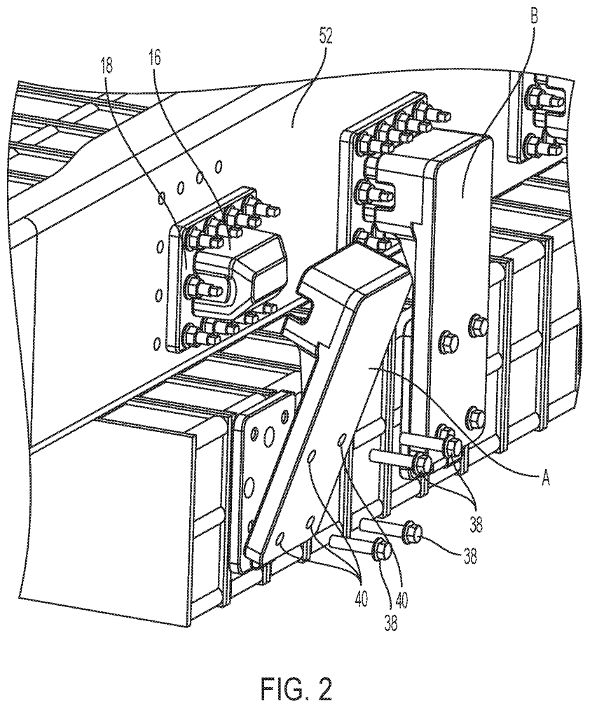

The first element 24 may move between a first position A and a second position B (FIG. 2). In the first position, the head portion fits over the bushing 16 as shown in FIG. 2 The head portion may slide over the top portion of the bushing 16, onto the taper of the bushing 16 to help hold the head portion in place on the bushing 16. In such manner, the component 12 may be secured to the vehicle frame via the bushing 16 without the need for any fasteners to connect the bracket to the vehicle frame. Advantageously, in embodiments where the bushing 16 is flexible, the component 12 and bracket assembly 24 are connected to the frame via the bushing in a simple shock absorbing manner without using fasteners to fix the bracket assembly 24 to frame rails 52.

In the second position B, the second interface structure 36 disengages from the bushing 16. This may facilitate the removal of the component 12 from the frame. The first element 24 moves off of the bushing 16, and the component may be removed.

In some embodiments, the first element 24 is situated over the bushing 16 to be in first position A. In other embodiments, the first element 24 may move between first position A nd second position B, in either direction, via a hinge, as is shown in FIG. 2. The first element 24 swings about the hinge between the positions A and B.

In some embodiments, the first element 24 may be further secured in the first position A, for example via fasteners 28, clamps, etc. Referring to FIG. 2, the first element 24 may include a plurality of holes 40 in its mid-portion 30. The component 12 may have corresponding holes that align with the holes 40 in the first element 24 when the first element 24 is in the first position A. The first element 24 moves about the hinge, upward in the context of FIGS. 1a and 1b, to position A. At least a part of the first element 24 overlaps with the component. Fasteners 38, for example fasteners of the type discussed above, may be inserted through the holes in the first element 24 and into the component to secure the first element 24 in the first position A as shown in FIGS. 1a and 1b. In this manner, the component may be secured to the frame via the bracket assembly 22. No fasteners are needed in between the bracket assembly 22 and the vehicle frame.

In addition, the holes 40 may also be provided in the component on either of or both sides of where the first element 24 is coupled to the component. For example, holes 40 may also be provided at location C and/or location D shown in FIG. 1b. In this example, the first element 24 may move, and be attached to the component in either direction, so that the component 12 may be attached to the vehicle frame in different positions. Another interface structure or a bi-directional interface may be provided at the head portion for this purpose.

In another exemplary embodiment, the bracket assembly 22 may be distinct from the component 12. As shown in FIG. 1b, the bracket assembly 22 may include a second element 40. Together, the first element 24 and the second element 40 form the bracket assembly 22. The second element 40 includes a first end 42 and a second end 44 opposite the first end 42. The first end 42 of the second element 40 is movably connected to the first end 26 of the first element 24. The connection between the first element 24 and the second element 40 may be done in a manner as described above, for example via a hinge, etc. The second element 40 has a first planar 46 surface between the first and second ends 42, 44. A second face 48 of the second element 40 is opposite the first face 36.

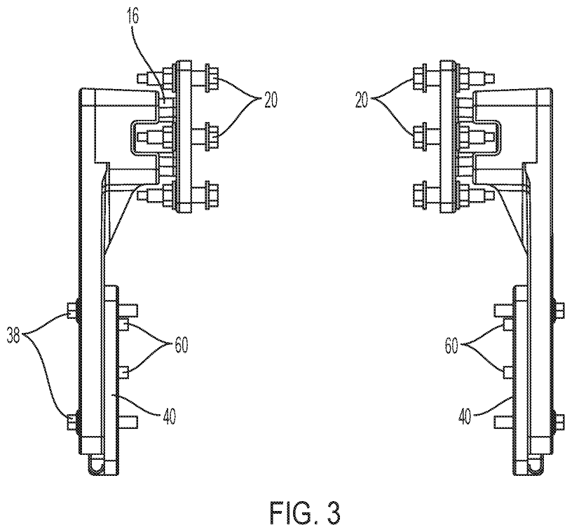

The second element 40 may be attached to the component 12, with the first face 46 of the second element 40 facing the component. For example, a plurality of holes may extend through the second element 40 to allow fasteners to be inserted to secure the bracket assembly 22 to the component. The first element 24 may be moved such that in the first position A the first face 32 of the first element 24 faces the second face 48 of the second element 40. That is, the first element 24 overlaps the second element 40 as shown in FIG. 3. Fasteners 38 extend through the first element 24 into the second element 40 to secure the bracket assembly 22 in the first position A. The fasteners 38 may not need to extend into the component 12, but this may be desired for heavier components. The second element 40 may be attached to the component 12 such that the first end 26 of the first element 24 is farther from the frame when installed, as shown in FIGS. 1a and 1b.

FIG. 3 illustrates the bracket assembly 22 and base part 14 without the component. Fasteners 20 for affixing the base part 14 to the frame are visible. Here, fasteners 60 extending from the second element 40 into the component to secure the bracket assembly 22 to the component are visible. Also, the fasteners 38 extending from the first element 24, through the second element 40 and into the component to secure the first element 24 into the second element 40 are visible. In the first position A, the first element 24 is flush against the second element 40 and the head portion of the first element receives the bushing 16.

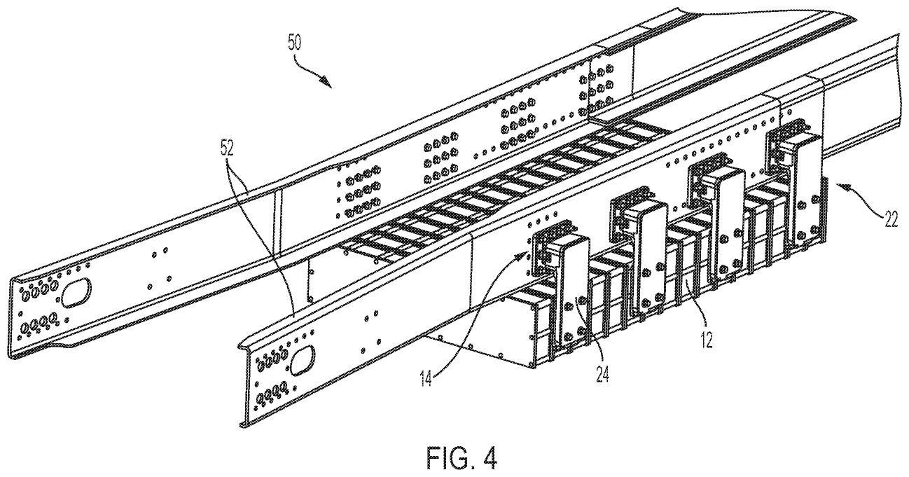

FIGS. 2 and 4 shows an example in which the component 12 is to be attached to a vehicle frame 50. The vehicle includes a pair of frame rails 52 spaced apart from each other. One or more base parts 14 are attached to each of the frame rails 52. A hinged bracket assembly 22 is attached to the component 12. The hinged bracket assembly 22 may be integral to the component or a separate bracket assembly 22 attached to the component as described above. If a separate component, the bracket assembly 22 may be attached to the component previously, or it may be attached to the component at the same assembly line station where the component is to be installed.

One or more bracket assemblies 22 may be attached to opposite sides of the component 12. During assembly, the component 12 is positioned under the frame rails 52 such that the bracket assemblies 22 are aligned with a respective base part 14. The component may be arranged between axle positions for the vehicle as noted above. Other locations for installation are also contemplated. The bracket assembly 22 is moved into the first position A, such that the head portion of the first element 24 fits over the bushing 16. The fasteners 38 are inserted through the first element 24 of the bracket assembly 22 to secure the bracket assembly 22 in the first position A. The component 12 may be suspended under the frame rails 52 or in the space between the frame rails 52, or both. As such, the length of the bracket assembly 22 and position of the base part 14 on the vehicle frame may vary accordingly.

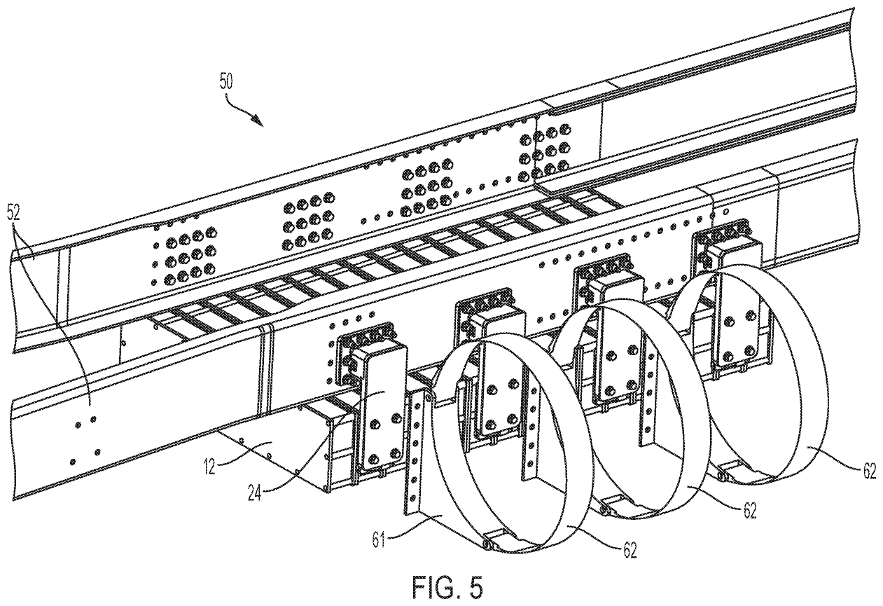

In some embodiments, additional components may be attached to the battery unit, the vehicle chassis or the bracket assembly. For example, FIG. 5 shows brackets 61 for a fuel tank. In this example the brackets 61 are attached to the battery unit. This may be done prior to or after the battery unit is attached to the vehicle frame. The brackets 61 may also be attached to the second face of the bracket assembly. The tank may be secured in place via straps 62.

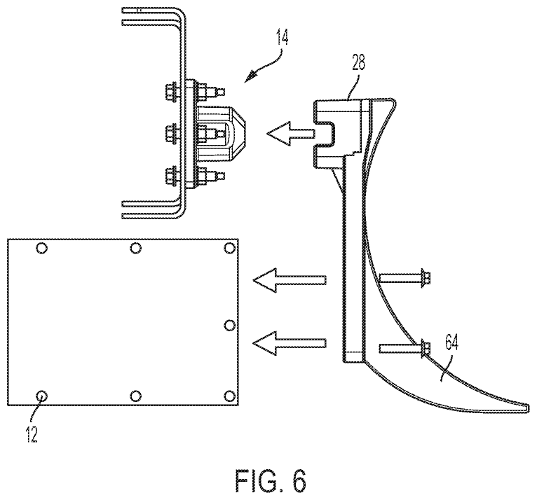

In an exemplary embodiment shown in FIG. 6, the bracket 22 may include an integral support 64 at surface 34. The integral support 64 may be used to attach another component via the bracket 22. Here, integral support 64 is an integrated fuel tank bracket. For example, the brackets 61 shown in FIG. 5 may be integrated as part of the bracket 22. Fuel tanks may be mounted on the outside of the frame 50 and the battery, and secured in place with straps 62. Other types of brackets may also be used. In the example shown in FIG. 6, the bracket 22 is a separate component from the battery. The bracket 22 having an integral support 64 may also be coupled directly or indirectly to the battery or other component via a hinge, etc. as described above and shown in, for example, FIG. 1A or 1B. The fuel tanks secured on opposite sides of the vehicle frame 50 may be different in size.

In the example of FIG. 6, a docking process uses the integrated fuel tank bracket to lock the battery pack onto the frame-mounted bushing 16. When this is done on both sides of the vehicle frame 50, the battery packs are securely fixed to the chassis. No screws or joints are needed at the bushing 16 to attach the bracket 22. The locking via the bracket connected to the battery pack. From here, fuel tanks may be added directly onto the brackets as normally done with chassis-mounted fuel tank brackets. This may remove the need for additional components and process steps, which saves time, cost, weight and makes for a more compact solution.

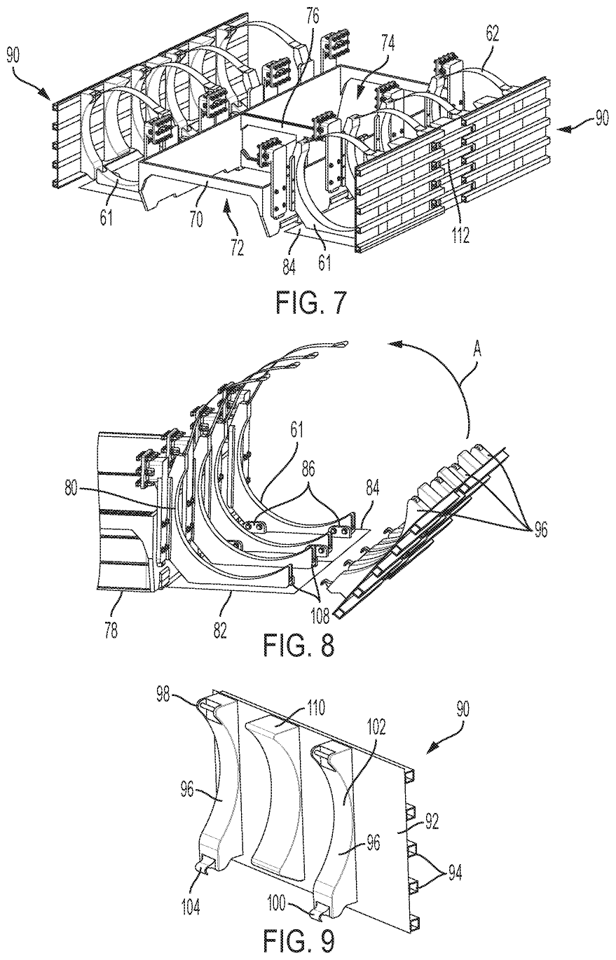

Turning to FIG. 7, an intermediary frame 70 for receiving components is shown.

The intermediary frame 70 may be sized to receive the components desired to be installed. For example, the intermediary frame 70 in this example is sized to receive battery packs. Here, the intermediary frame 70 can receive and support two battery packs. One battery pack may be arranged in a front compartment 72 and a second battery pack may be arranged in a second compartment 74. A cross bar 76 may separate the compartments 72, 74, and also provide stabilization support. The intermediary frame 70 may also include a bottom panel 78 (FIG. 8). The bottom panel 78 may be removeable from the intermediary frame 70 so that the battery pack or other component may be removed after the installation is attached to a vehicle chassis. One or more intermediary frames may be used, with the plurality of frames rigidly connected together.

When an intermediary frame 70 is provided, the brackets 22 may be coupled to the intermediary frame 70 as shown in FIG. 7, as opposed to being coupled to the batteries of battery pack as described above. The separate fuel tank brackets 61 may also be connected to the intermediary frame 70 as shown in FIGS. 7 and 8. In some embodiments, for example when the intermediary frame or component is not utilized, the fuel tank brackets 61 may be coupled to the vehicle frame. A vertical component 80 of the fuel tank bracket 61 is coupled to the intermediary frame 70. A horizontal component 82 of the fuel tank bracket 61 extends outwardly. The horizontal component 82 of the fuel tank brackets 61 may be configured to extend under and hold the fuel tank in place during the assembly process, without the need for straps which may be later installed.

Bottom plates 84 may be attached to the fuel tank brackets 61. The bottom plate 84 may provide protection to the fuel tanks. Bottom plate 84 is arranged underneath the horizontal component 82 of the fuel tank bracket 61. An intermediary bracket 86 may be used to connect the bottom plate 84 to the fuel tank bracket 61. The intermediary bracket 86 may define openings via which a fastener is inserted through the opening, and into the fuel bracket 61. The fasteners may be screws, bolts, or other types of fasteners. The screws may be inserted in a horizontal direction of FIG. 8 into the fuel tank bracket 61. The intermediary bracket 86 may be connected to the bottom plate 84 in a similar fashion, via a fastener inserted through a hole in the bottom plate 84. This allows the bottom plate 84 to be removed from the fuel tank bracket 61 without the need to remove or access the intermediary brackets 86, which may be obscured by the fuel tank installed on the fuel tank bracket 61.

Turning to FIG. 9, a crash protection structure 90 may be provided. The crash protection structure 90 may be arranged on the side of the fuel tanks opposite the chassis as shown in FIG. 7. The crash protection structure 90 may include a protection plate 92, such as a metal plate. The protection plate 92 may include reinforcing structure 94. The reinforcing structure 94 may be rods or bars on the exterior of the plate 92. The reinforcing structure 94 may be arranged horizontally as shown, or in other ways.

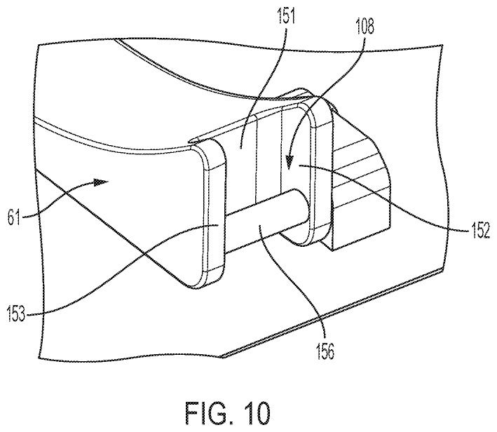

Attachment brackets 96 configured to fit the fuel tanks are provided on a side of the protection plate 92 facing the fuel tanks. The brackets 96 have a top end 98, a bottom end 100, and surface 102 that fits an exterior profile of the fuel tank. At the bottom end 100, the brackets 96 also include a hook-type end, such as hook 104, to hook onto the fuel tanks brackets 61. The fuel tank brackets 61 may include a recess 108 to receive the hook. The hook 104 may be inserted into the recess 108, angled away from the fuel tank, then rotated upward along arrow A into place. A rod, bar or other structure may be arranged in the recess 108 to interface with the hook, and hold it in place when the plate 92 is rotated upward. FIG. 10 is a detailed view of the fuel tank bracket 61. Walls 151, 152, and 153 define recess 108 for receiving hook 104. Element 156 extends between walls 152 and 153 within recess 108. Element 156 may be a rod, bar, or the like.

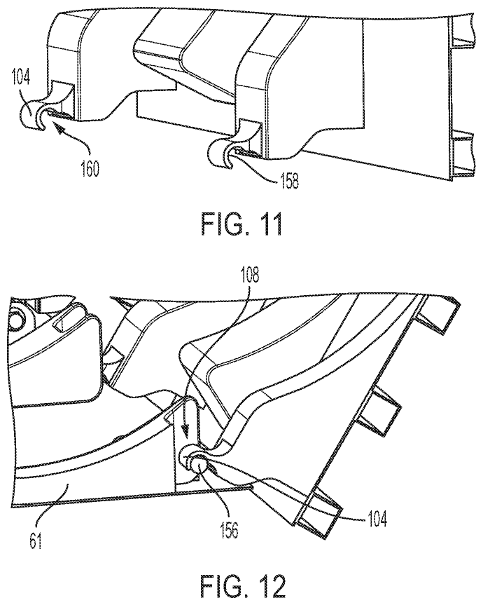

FIG. 11 is a detailed view of hook 104. Hook 104 has an inner surface 158 adapted to interface with element 156. Hook 104 defines an opening 160 to receive element 156.

The opening 160 should be large enough so that the hook 104 can be placed onto element 156. FIG. 12 is a cross section view showing an example of hook 104 arranged on element 156 when the crash protection structure 90 is being attached to the fuel tank bracket 61. Crash protection structure 90 is arranged at an angle so that the hook 104 is inserted into recess 108 such that element 156 fits into opening 160. Inner surface 158 of the hook 104 then interfaces with element 156. The crash protection structure 90 may be rotated about element 156, in the direction of arrow A in FIG. 8, to hold the crash protection structure 90 in place.

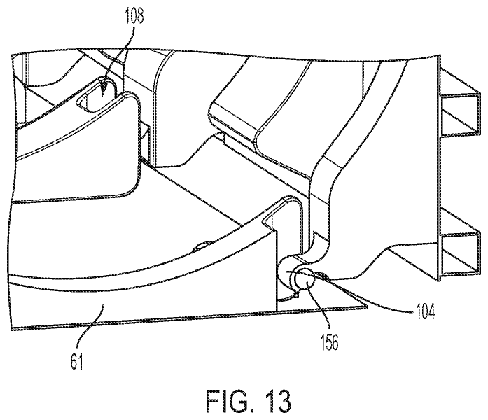

FIG. 13 is a cross section view of the fuel tank bracket 61 and hook 104 showing the crash protection panel secured in place on the fuel tank bracket 61. The interaction between the hook 104 and the recess and element 156 holds the crash protection panel in place. The top end 98 of the attachment bracket 96 on the protection plate 92 may include an interface for receiving the strap 62. The strap 62 can be connected at the interface to secure the strap 62 in place over the fuel tanks. Strap 62 may also secure a top end of the crash protection structure 90 in place adjacent the fuel tank.

Safeguards 110 may also be provided on the plate 92, in between the fuel tanks and the plate 92. Safeguard 110 has a profile that fits the outer profile of the fuel tank, and fits against the fuel tank when the plate 92 installed. The safeguard 110 may be made from, for example, a dense foam material. Safeguard 110 may help to distribute the energy from any impact across the fuel tanks in a more even manner than just the brackets.

The crash protection structure 90 may have a modular form. For example, the plates 92 may have the same length and be connected together via middle support 112. The middle support 112 may be connected in between two crash protection structures 90. The middle support 112 may have different lengths in order to fit a range of different fuel tank lengths. Also the plates 92 may have different lengths, and a height sufficient to extend above the fuel tanks.

When the fuel tanks are fixed to the battery packs or the intermediary frame, the complete unit of fuel tanks and batteries may be suspended as one mass, which reduces overall accelerations and improves on durability for the complete installation.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (just X, or just Y, or just Z) and multiple items (i.e., {X and Y}, {X and Z}, {Y and Z}, or {X, Y, and Z}). “At least one of” is not intended to convey a requirement that each possible item must be present.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. An apparatus for securing components to a vehicle, comprising:
a base part adapted to be attached to a frame of a vehicle, the base part including a first interface structure; and
a bracket assembly including a first element having a first end and a second end, the first end being movably coupled to the component; a second interface structure arranged at the second end, wherein the first element is configured to move between a first position in which the second interface structure engages with the first interface structure to secure the component to the frame via the bracket assembly and a second position in which the second interface structure is disengaged from the first interface structure.

2. The apparatus of claim 1, wherein:
the vehicle includes a frame rail;
the first interface structure includes a protrusion that extends in a horizontal direction laterally outward from the frame rail and includes a bottom portion located closer to the frame than a top portion that extends laterally outward relative to the frame and the bottom portion; and
the second interface structure engaging the protrusion when in the first position and extending circumferentially around the protrusion, whereby the bracket assembly and component are connected to the frame rail via the protrusion.

3. The apparatus of claim 2, wherein the first interface structure comprises a flexible bushing.

4. The apparatus of claim 3, wherein the bushing has a first stiffness in a vertical direction to absorb a weight of the component, and a second stiffness in a horizontal direction.

5. The apparatus of claim 1, wherein the bracket assembly further comprises a second element, the second element includes a first end and a second end opposite the first end, a first face between the first and second ends of the second element and facing the component when attached to the component, and a second face opposite the first face, and wherein the first element includes a first face between its first and second ends, and a second face opposite the first face, wherein the first end of the first element is rotatably connect to the first end of the second element, and in the first position the first face of the first element faces the second face of the second element.

6. The apparatus of claim 5, wherein the second face of the first element is configured to receive a fuel tank bracket.

7. The apparatus of claim 5, further comprising fasteners extending through the first element into the second element and/or the component to secure the bracket assembly in the first position.

8. The apparatus of claim 1, wherein the component is at least one of an intermediary frame, battery module, tool box, and fuel tank.

9. The apparatus of claim 8, wherein the component is the intermediary frame, and further comprising:
a fuel tank bracket attached to the intermediary frame, the fuel tank bracket having a horizontal component and a vertical component, and a profile configured to receive a fuel tank, the vertical component having a top end, the horizontal component having a bottom end, the bottom end defining a recess to receive a hook;
a panel having two faces opposite each other;
a complimentary fuel tank bracket attached to a first of the faces of the panel, the complimentary fuel tank bracket having a top end, a bottom end, and surface therebetween to correspond to an exterior profile of the fuel tank, the complimentary fuel tank bracket includes a hook at the bottom end configured to interface with the recess of the fuel tank bracket.

10. The apparatus of claim 8, further comprising a safeguard connected to the panel, the safeguard having a profile corresponding to the exterior profile of the fuel tank.

11. The apparatus of claim 8, further comprising a reinforcing structure provided on a second of the faces of the panel.

12. The apparatus of claim 9, wherein the reinforcing structure comprises horizontal ribs.

13. The apparatus of claim 8, further comprising a strap connected between the top end of the fuel tank bracket and the top end of the complimentary fuel tank bracket.

14. The apparatus of claim 8, further comprising an interface panel; the interface panel connected in between the panel and a second panel to hold the panel and the second panel together.

15. The apparatus of claim 8, further comprising:
a plurality of fuel tank brackets coupled to the intermediary frame, and spaced apart from each other; and
a bottom panel, the bottom panel connected to the horizontal component of each of the fuel tank brackets, and extending across the spaced apart distance in between the fuel tank brackets.

16. A vehicle, comprising:
a pair of frame rails spaced apart from each other and defining a space therebetween;
base parts coupled to each of the frame rails, the base parts including a first interface structure facing outwardly from the space between the frame rails;
bracket assemblies, each having a first end and a second end, the second end provided with a second interface structure complementary to the first interface structure, the first ends being moveably attached at opposite sides of a component in order to move between a first position in which the second interface structure engages with the first interface structure to secure the component to the frame rails via the bracket assembly and a second position in which the second interface structure disengages from the first interface structure; and
fasteners securing the bracket assembly to the component in the first position, whereby the component is coupled to the frame rails via the bracket assemblies.

17. The vehicle of claim 8, wherein the component is disposed in the space between the frame rails.

18. The vehicle of claim 8, wherein the component is suspended below the frame rails via the bracket assembly.

19. The vehicle of claim 8, wherein the first interface structure comprises a bushing.

20. The vehicle of claim 11, wherein the bushing is attached directly to frame rail.

21. The vehicle of claim 8, wherein the bracket assemblies further comprise:
a first element having the first end, the second end opposite the first end, a first face between the first and second ends, and a second face opposite the first face; and
a second element including a first end and a second end opposite the first end, the first end rotatably coupled to the first end of the first element; a first face between the first and second ends of the second element and facing the component; and a second face opposite the first face, wherein in the first position the first face of the first element faces the second face of the second element.

22. The vehicle of claim 8, wherein the fasteners extend through the bracket assembly towards the component.

23. The vehicle of claim 13, further comprising a fuel tank bracket connected to at least one of the second faces of the first elements.

24. The vehicle of claim 13, further comprising a plurality of base parts coupled to each frame rail and a corresponding number of bracket assemblies.

25. The vehicle of claim 8 further comprising a second component coupled to the component or to the bracket assembly opposite of the component.

26. The vehicle of claim 8, wherein the base parts are arranged on sides of the frame rails facing away from the space between the frame rails.

27. The vehicle of claim 8, wherein the bracket assemblies include an integral support surface.

28. A method of securing a component to a vehicle, the vehicle having a pair of frame rails spaced apart from each other and defining a space therebetween, the method comprising:
attaching a base part to each of the frame rails, outside of the space between the frame rails, the base parts each including a first interface structure;
providing a component having a bracket assembly, the bracket assembly including a first end and a second end opposite the first end, the second end having a second interface structure complementary to the first interface structure, the first end being moveably attached to the component, the bracket assembly being moveable to a first position in which the second interface structure engages with the first interface structure to secure the component to the frame rails via the bracket assembly;
positioning the component under the frame rails such that the bracket assembly is aligned with a respective base part;
moving the bracket assembly into the first position; and
securing the bracket assembly into the first position.

29. The method of claim 20, wherein the bracket assembly comprises a first element having the first end, the second end opposite the first end, a first face, and a second face opposite the first face; and a second element including a first end and a second end opposite the first end, the first end rotatably connect to the first end of the first element, a first face between the first and second ends of the second element and facing the component, and a second face opposite the first face, wherein in the first position, the first face of the first element faces the second face of the second element, and the method further comprises:
moving the first element to the first position such that the second face of the second element faces the second face of the first element; and
attaching the first element to the second element to secure the bracket assembly in the first position.

30. The method of claim 21, wherein the securing the bracket assembly into the first position comprises inserting fasteners through the first element towards the component and into the second element to secure the bracket assembly in the first position.

31. The method of claim 20, further comprising attaching the bracket assembly to the component.

32. The method of claim 20, further comprising attaching a fuel tank bracket to component.

33. An apparatus, comprising:
an intermediary frame configured to house a component;
a fuel tank bracket, the fuel tank bracket having a horizontal component and a vertical component defining a profile configured to receive a fuel tank, the vertical component having a top end, the horizontal component having a bottom end, the bottom end defining a recess to receive a hook, the vertical component being attached to the intermediary frame;
a panel having two faces opposite each other; and
a complimentary fuel tank bracket attached to a first of the faces of the panel, the complimentary fuel tank bracket having a top end, a bottom end, and surface therebetween defining a profile configured to receive the fuel tank, the complimentary fuel tank bracket includes a hook at the bottom end configured to interface with the recess at the bottom end of the fuel tank bracket.

34. The apparatus of claim 32, further comprising a safeguard connected to the first of the faces of the panel, the safeguard having a profile configured to receive the fuel tank, the safeguard being made of a dense foam material.

35. The apparatus of claim 32, further comprising a reinforcing structure provided on a second of the faces of the panel.

36. The apparatus of claim 34, wherein the reinforcing structure comprises horizontal ribs.

37. The apparatus of claim 32, further comprising a strap connected between the top end of the fuel bracket and the top end of the complimentary fuel bracket.

38. The apparatus of claim 32, further comprising an interface panel connected in between the panel and a second panel to hold the panel and the second panel together.

39. The apparatus of claim 32, further comprising:
a plurality of fuel tank brackets coupled to the intermediary frame, and spaced apart from each other; and
a bottom panel, the bottom panel connected to the horizontal component of each of the fuel tank brackets, and extending a same width as the horizontal component and along the spaced apart distance in between the fuel tank brackets.

40. An apparatus, comprising:
a fuel tank bracket, the fuel tank bracket having a horizontal component and a vertical component defining a profile configured to receive a fuel tank, the vertical component having a top end, the horizontal component having a bottom end, the bottom end defining a recess to receive a hook, the vertical component being attached to a vehicle frame;
a panel having two faces opposite each other; and
a complimentary fuel tank bracket attached to a first of the faces of the panel, the complimentary fuel tank bracket having a top end, a bottom end, and surface therebetween defining a profile configured to receive the fuel tank, the complimentary fuel tank bracket includes a hook at the bottom end configured to interface with the recess at the bottom end of the fuel tank bracket.
